(19) United States
(12) Patent Application Publication
(10) Pub. No.: US 2005/0131761 A1
(43) Pub. Date: Jun. 16, 2005

(54) Mobile digital coupons

(76) Inventors: Sanjeev N. Trika, Hillsboro, OR (US); Carl S. Marshall, Portland, OR (US); Adam T. Lake, Portland, OR (US); Robert C. Knauerhase, Portland, OR (US)

Correspondence Address: Joni D. Stutman-Horn;BLAKELY, SOKOLOFF, TAYLOR & ZAFMAN LLP, Seventh Floor, 12400 Wilshire Boulevard, Los Angeles, CA, 90025-1030, US

(21) Appl. No.: 10/738,023

(22) Filed: Dec. 16, 2003

(51) Int. Cl. G06F 17/60

(52) U.S. Cl. 705/14

(57) ABSTRACT

A system and method is disclosed for providing a reward-based digital mobile coupon environment, where the digital coupons may be shared among peers. Consumers utilize mobile digital coupon carriers having digital representations of coupons. Sharing of coupons among peers may be rewarded with additional discounts or points. The digital coupon carriers communicate with electronic coupon terminals at retail locations for automatic coupon redemption. A coupon may correspond to a globally unique identifier in order to track usage, sharing and redemption. Coupon use and sharing may be dependent upon stored user profiles, merchant profiles and policies, or programs embedded in the coupon.

### FIELD OF THE INVENTION

An embodiment of the present invention relates generally to discounting goods and services with coupons and, more specifically, to a system and method for providing a reward-based digital mobile coupon environment, where the digital coupons may be shared among peers.

### BACKGROUND INFORMATION

Various mechanisms exist for retrieving, storing and using coupons to attain a discount on goods or services. The common coupon usage model for consumers is to see a coupon for an item of interest for purchase, cut/print it, go to the store, and use it. There are several key problems with this model: 1) Users may not be aware of relevant coupons. 2) Even when they are aware of the coupons, the users often forget to carry/use the coupons. 3) Personalization of coupons, and targeting of likely consumers, is hard for manufacturers and retailers deploying paper coupons.

Merchants and vendors of goods and services often accept coupons to provide a consumer with discount on goods and services. Today, coupons are typically distributed in print, e.g., newspapers, magazines, or by direct mail. Consumers clip coupons and then take the coupons to the store. Sometime coupons are available at the point of sale in coupon books or coupon dispensing units, for instance in a grocery store. Coupons may also be printed from a vendor or merchant's web page, such as http://www.coupons.com and http://www.rebates.com. Downloading coupons from a web page can be problematic when a printer is unavailable, for instance when in a hotel room. The coupons may be stored in one's purse, wallet, envelope or other coupon sleeve for transport to the store.

An alternative to print coupons are what have been called “no-clip coupons.” A merchant will advertise an item at a reduced sale price and may not require the consumer to have a printed coupon. This method amounts to a simple reduction in price and is not easily trackable to a consumer. Some no-clip coupon schemes require a consumer to register as a customer and carry a scannable card or token. The card or token is scanned at the check-out register and a predetermined discount is applied to selected items. Some merchants allow the consumer to provide a telephone number in lieu of the card or token to allow for a lost or forgotten card/token.

In particular for manufacturer coupons, a merchant accepts the coupons and then sends them to a coupon clearinghouse or directly to the merchant for reimbursement of the coupon face value, or portion of face value.

The method of using coupons in the prior art makes storage of coupons difficult. Even if a consumer stores coupons in one place, finding a coupon for a specific item may be difficult if the quantity of saved coupons is large. Further, the collection of coupons is cumbersome. Consumers must scour newspapers and other print media to find coupons of interest. Consumers must then remember to take specific coupons to the merchant location.

### BRIEF DESCRIPTION OF THE DRAWINGS

The features and advantages of the present invention will become apparent from the following detailed description of the present invention in which:

FIG. 1 is a block diagram of an exemplary communication system which may be used with an embodiment of the system and method described herein;

FIG. 2 is a block diagram of an alternate embodiment of the present system and method;

FIG. 3 is a flow diagram of an exemplary usage model for authenticating digital mobile coupons; and

FIG. 4 is a flow diagram of an exemplary usage model for acquiring and using digital mobile coupons.

### DETAILED DESCRIPTION

An embodiment of the present invention is a system and method relating to digital mobile coupons. In at least one embodiment, coupons are stored in a digital format in a mobile device such as a personal digital assistant (PDA), mobile coupon carrier, mobile phone, or other device (hereafter, generically, “digital coupon carrier” or DCC). Manufacturers may distribute coupons over the world wide web (“Web”). A consumer may download the coupons onto a home computer or directly to the digital coupon carrier. The user takes the digital coupon carrier to the merchant location. Upon checkout an electronic coupon terminal (ECT) accesses the consumer's digital coupon carrier and applies any applicable discounts. With this method, the user never has to touch a physical incarnation of the coupon.

Reference in the specification to “one embodiment” or “an embodiment” of the present invention means that a particular feature, structure or characteristic described in connection with the embodiment is included in at least one embodiment of the present invention. Thus, the appearances of the phrase “in one embodiment” appearing in various places throughout the specification are not necessarily all referring to the same embodiment.

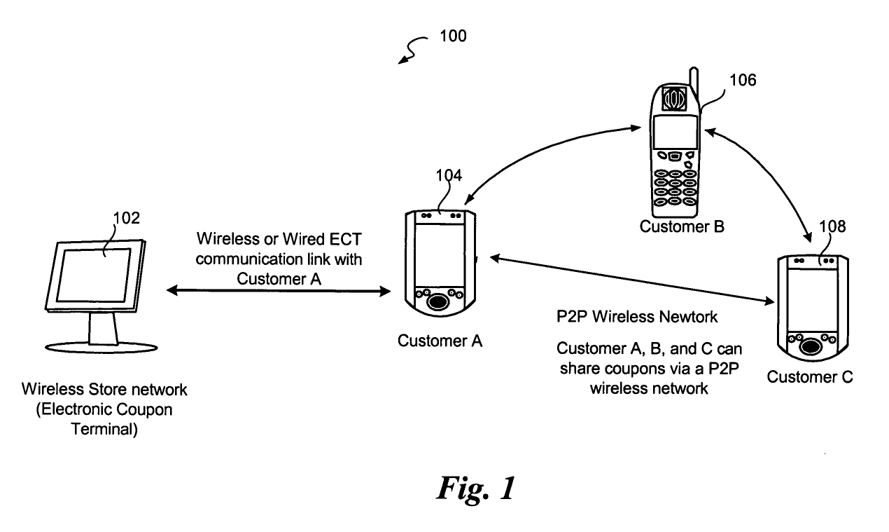

FIG. 1 is a block diagram of an exemplary communication system 100 which may be used with an embodiment of the system and method described herein. An electronic coupon terminal (ECT) 102 resides at a merchant location. The ECT may be integrated with a checkout register, or cashier. The ECT may store all information necessary to authorize coupons for goods or services provided by the merchant. The ECT may communicate via wired or wireless connection to a consumer's digital coupon carrier (DCC).

A Customer A has a DCC in the form of a personal digital assistant (PDA) 104. Customer B has a DCC in the form of a mobile phone 106. A Customer C has a DCC in the form of a PDA 108. It will be apparent to one of ordinary skill in the art than any programmable mobile device may be configured to act as a digital coupon carrier. The DCC's 104, 106 and 108 may be equipped with wireless capability in the form of Bluetooth, 802.11(b) or other standard protocol.

Customers A, B and C use their DCC device 104, 106, 108 upon checkout at the cashier to attain discounts associated with stored digital coupons. The digital coupons are read and authorized by the ECT 102. A DCC may communicate wirelessly to the ECT or be connected via a wired cradle (not shown) or other connector.

In one embodiment, coupons may be collected from other consumers over a peer-to-peer network, automatically. A request for a coupon for a specific item is sent (typically wirelessly). Other consumer's digital coupon carriers may answer the request by sending the requested coupon. In some embodiments, alternative, but similar, coupons are returned, for instance, for a competitor's product. In some embodiments the ECT or other local device may answer the request with a digital coupon. In some embodiments, the consumer's DCC selects the most cost effective coupon when more than one coupon is received in response to a request. Sharing of coupons is a feature that does not exist in the methods of the prior art. A coupon may be associated with a flag that indicates whether or not it is sharable. Non-sharable coupons, for instance, one-use-only coupons, are not returned in response to a request.

In one embodiment, if a consumer shares a coupon, the consumer may receive an award. Awards may be in the form of additional discounts, or points that may be redeemed for cash or merchandise. Rewards help build consumer loyalty to a manufacturer or merchant. Electronic organization and storage of coupons makes collecting and using coupons easier and more efficient for the consumer.

Programmable devices, such as a DCC, provide the opportunity to create interactive experiences and the ability to create a coupon that has a small program to detect information and create a custom experience based on this data. Some examples of input to the program include expiration dates of produce or shelf life of food, the number of coupons already redeemed, the proximity to product in store, etc. An embodiment of the present system and method allows exploitation of the social aspects of having a wireless, peer to peer network of friends, neighbors, and family members that could share coupons. Sharing of coupons is motivated by increasing incentives such as micropayments or additional offers from the merchant or vendors.

Electronic coupons may be distributed and stored on a DCC in a variety of ways. Example ways in which a business could distribute a digital coupon to a mobile device include: posting on Web sites for wired/wireless downloads; scanning of coupon images or barcodes in traditional print media; via email to preferred, registered, or requesting consumers; at stores as promotions via electronic transmitters; and peer to peer networks of mobile devices. It will be apparent to one of ordinary skill in the art that other coupon distribution schemes exist and may be employed with no impact to the method and systems as described herein.

A coupon may be stored on a DCC in a variety of formats: e.g., bar code, globally unique identifier (GUID), coupon code, or image, or a coupon record including the relevant coupon data. The format may be chosen by a business depending on the discount policies they want to enforce. Once digitally stored on the mobile device, the coupon(s) may be retrieved at a later date. The coupons may be categorized and organized on the mobile device into data files automatically or manually in an order determined by the user (e.g. organized by expiration date, type of purchase, name of retailer, etc) or with a default organization policy. The DCC may automatically synchronize, on a pre-specified schedule, with a registered set of Web sites/product sites to update its coupons. DCC handheld may retain the best coupons and automatically delete any expired or undesirable coupons.

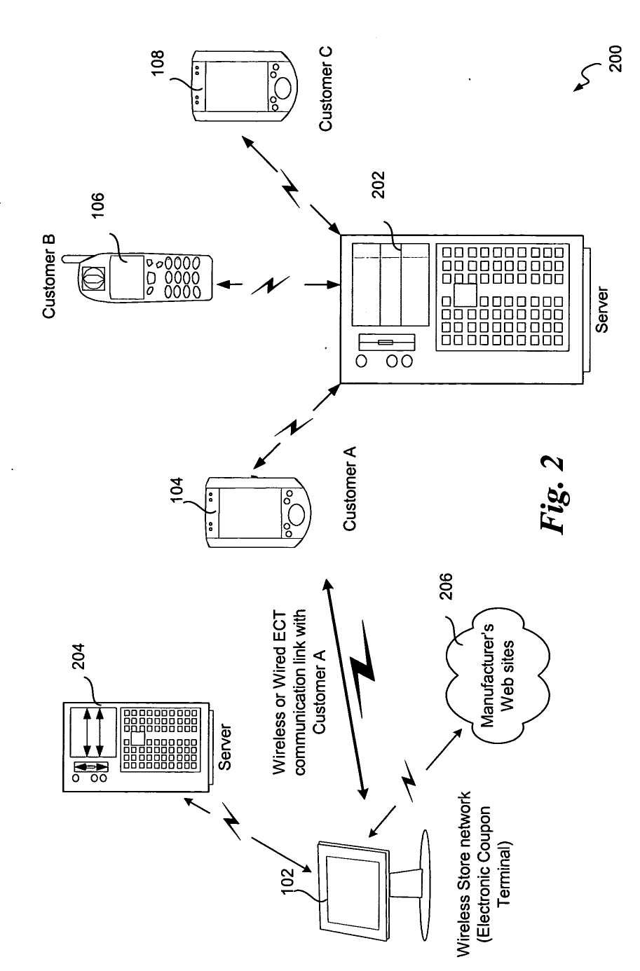

Referring now to FIG. 2, there is shown an alternate embodiment of the present system and method. In some embodiments, the ECT 102 may be communicatively coupled to a server 204. The server may contain business policies, coupon policies, and promotional information. The ECT may retrieve all necessary authorization information from server 204 rather than having to store all of the information locally.

In some embodiments, a customer DCC 104, 106 and 108 communicates with a server 202 rather than directly to peer DCCs. One scenario for sharing digital coupons may be for server 202 to request a copy of all sharable (or discardable/unwanted) coupons when a customer enters a retail establishment. The digital coupons are stored on the server 202 until another customer sends a coupon request. This enables a consumer to share coupons but avoid their DCC from being bombarded with requests every few seconds or minutes. A user profile may exist on the DCC to identify types of coupons to always discard or request.

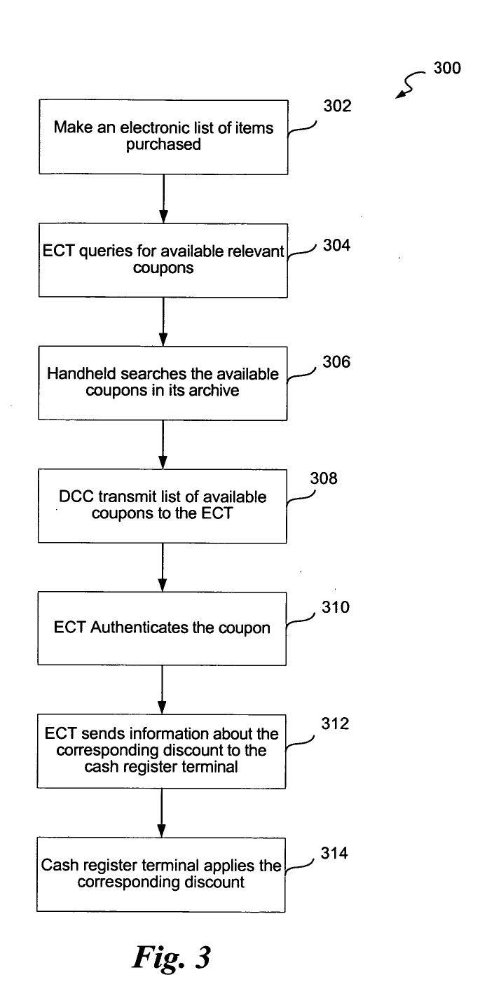

A number of usage models may exist for various embodiments of the invention. Referring now to FIG. 3, there is shown an exemplary usage model 300. In one embodiment, the process for using a digital coupon is as shown. Upon checkout, the cash register makes an electronic list of items purchased in block 302. This list is sent via a wireless or tethered means to the retailer's electronic coupon terminal (ECT). The ECT may be the same terminal that is used for mobile digital receipts or may also be implemented as an extension to the typical checkout scanner or cash register.

The ECT connects (tethered or wireless) to the customer's handheld digital coupon carrier (DCC) and queries for available relevant coupons in block 304. The DCC searches the available coupons in its archive (block 306), and transmits these back to the ECT in block 308. The ECT uses the coupon id (or bar code or GUID) to look up the coupon data in a coupon database, authenticates the coupon in block 310 (e.g., checks the expiration date, and ensures that corresponding items are purchased). Once the coupon has been authenticated, the ECT sends information about the corresponding discount to the cash register terminal in block 312. The cash register terminal applies the corresponding discount to the item's purchase price in block 314, and may send an acknowledgement of receipt to the ECT.

In some embodiments, the ECT may enforce any of business' coupon policies. For instance, if a business limits one coupon per customer, then the ECT may mark the coupon GUID as used in the coupon database; this requires a unique GUID per coupon per person.

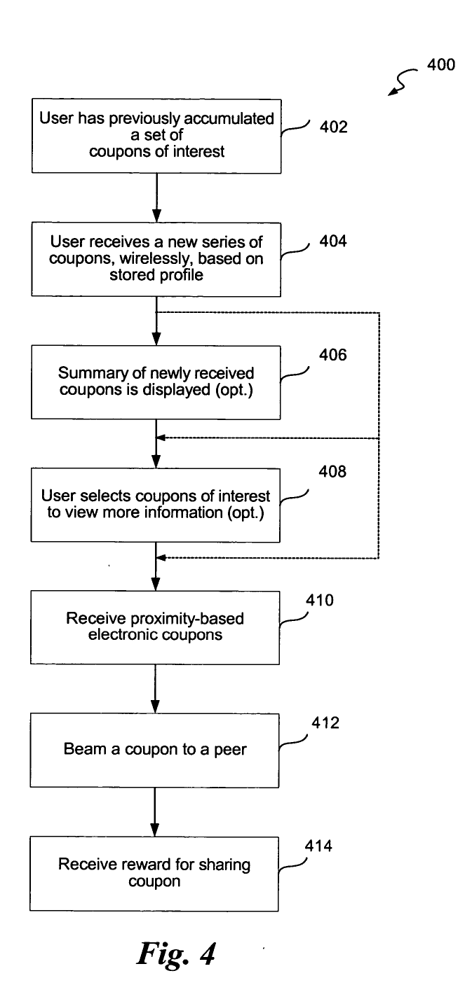

Referring now to FIG. 4, there is shown another usage model 400 for mobile digital coupons. A user may have previously accumulated a set of coupons of interest (block 402). The user enters a retail establishment and may receive a new series of coupons in block 404. The user may see a summary of the new coupons that have downloaded in block 406. The user may select coupon(s) of interest to view more information in block 408.

Since the retailer or manufacturer is motivated to make an impression or image on the consumer, not just a sale, in one embodiment, the user may click on the incentive and view a color, potentially interactive image of the brand, or perhaps watch a short animation. In one embodiment, only after viewing the advertisement is the user permitted to use the coupon. In this embodiment, the programmable devices (DCC) are coupled with reasonable resolution video to allow content creators (coupon creators) to create interactive experiences requiring varying amounts of engagement from the consumer to obtain a discount. Sometimes it might be desirable to have a short video segment then provide the coupon, other times it would be to provide profile information (research shows users are willing to disclose private information for an incentive). One can also imagine, in particular for younger audiences, the motivation of obtaining a certain score or objective in a short game to obtain a coupon. “Play a game and help your parent save a buck on your favorite cereal.”

In one embodiment, as the user may be exposed to more offered coupons while roaming through a retail establishment (block 410). These additional coupons may be proximity-based, i.e., when the user nears certain areas of the store that sell items the user doesn't normally purchase, a coupon will be automatically downloaded to the DCC. In some embodiments, advertisements for the coupons will automatically be displayed. If, for instance, the store is trying to move apples that week, the user may be presented with the apple sale. Likewise, the user may be able to look up information, either locally on their mobile device or via the mobile device on a server, that describes the types of apples available, the tastes, and perhaps recipe suggestions (which again motivates increased purchasing).

In another embodiment, a user may explicitly transmit a coupon to a friend or acquaintance (block 412). When the user checks out, they run into a friend. This friend makes small talk and then may inquire about what coupons the user found valuable. These coupons may be beamed via infrared, 802.11(b) or other transmission means from person to person. The beamer may receive an reward, or payment, perhaps a financial incentive or additional rebates, for the beam (block 414). Some incentives may be received only if the coupon is actually used. These policies may be stored on a server, ECT or on the DCC. A flag for whether the beamed coupon has been used may correspond to a GUID for the beamed coupon and the flag may reside on the manufacturer or retail establishment server. When the user next connects to the server, the flag is checked to determine whether the reward should be applied.

If business coupon policy permits, a coupon may be shared by consumers, e.g., upon checkout, the ECT or the DCC may automatically broadcast over a wireless network a request for coupons for the purchased items. In this case, if a coupon exists for an item on a DCC of any consumer in the store, it may be downloaded and applied. In case multiple coupons exist, the best one may be automatically or manually picked.

The ECT may enforce all policies associated with the coupon. For instance, some coupons may be valid only one to a customer. Other coupons may be limited to 100 customers. Some coupons may not be able to be shared. Undesirable coupons may be discarded by a consumer. Proximity to an item in a store may cause a coupon to be sent to a DCC. In some embodiments, consumers may have profiles stored on the digital coupon carrier which filter coupons sent to the consumer's DCC. The profile may determine whether a consumer is willing to share coupons (in either direction).

Another embodiment facilitates the collection of a rebate. Currently, to take advantage of a rebate offer, the consumer must save the universal product code (UPC) from an item's label, and send the UPC and original receipt to the manufacturer to collect the rebate. As postage fees rise, this method renders low cash value rebates less and less desirable. Further, this rebate method requires a consumer to act within a certain time period. Many available rebates go uncollected due to missed time windows and lost receipts. In one embodiment, a profile in the DCC may hold the consumer's address and other identifying information. When a rebate offer is available for a purchased item, the DCC may automatically send the rebate information to the rebate clearinghouse, thereby saving the consumer time and postage. In one embodiment, a flag may be stored on the DCC indicating whether the rebate request should be manual or automatic.

In another embodiment, a coupon may have a varying effective value based on time. For instance, a coupon may be worth $1.00 within the first two weeks of receiving it. After that time period has expired, the coupon may only be worth $0.50 for the next two weeks, etc. In another embodiment, the time period for using coupon redemption may be very short. For instance, a digital coupon may be received that expires (or reduces in value) in minutes, or hours. This may be useful for proximity-based coupon downloads, in order to encourage the shopper to purchase a product on this trip to the merchant, not the next trip. The coupon usage scheme, or policy, may reside in the stored coupon. In some embodiments, the policy may be stored on the ECT.

Types of information that may be stored with the coupon include: Product name; Product size; Expiration date; Authorized stores; Authorized usage (number of times); Shared (Y/N); Rebate?; Discount as a function of time; and Combine coupon across products? i.e., link to another coupon. Some policies may be stored with the coupon and others may be stored in the ECT or a server accessible to the ECT or DCC.

In some embodiments, the product name is associated with a bar code. In other embodiments, the product name is associated with a globally unique identifier (GUID). A GUID allows the merchant or vendor to control how may times the coupon may be used. Each individual coupon may be assigned its own GUID. A 128-bit GUID, which is typically what is used today, allows sufficient unique identifiers for this method to be used. Currently, GUIDs are used in systems using an extensible firmware interface (EFI) to identify various hardware devices. It is contemplated that there are enough unique GUIDs to accommodate usage in EFI systems, the method described herein, as well as other usages not yet implemented. This disclosure, however, is not limited to 128 bit GUIDs and other suitable unique identifiers may be used.

Limited use coupons may be given away (consumer-to-consumer) but not copied from consumer-to-consumer. A coupon may be “beamed” to another consumer, in a similar manner as address cards are beamed from one PDA to another. These coupons may have a corresponding GUID so that they may be tracked and easily limited.

As discussed above, some coupons may be animated. A coupon may have an imbedded program. The program may contain a policy or advertisement. An advertisement or expiration reminder may be displayed on a viewable element of the DCC.

In another embodiment, coupons may be scanned into the DCC. Once the consumer is in proximity of an ECT, the coupon may be synchronized with its corresponding coupon information. It is well known in the art that scanned images can be recognized using various pattern recognition and character recognition techniques. In one embodiment, the consumer enters a product name. In another embodiment, an identifier or GUID is scanned, but the graphic image of the scanned coupon is discarded.

In one embodiment, the consumer may select items or categories of interest to set a profile. When the consumer is in proximity of an ECT or other coupon sending device, it will only accept coupons for items/categories of interest. This enables one octogenarian couple to refuse diaper coupons, but enables another octogenarian couple with grandchildren to accept diaper coupons (for later transmittal to the parents of the grandchildren).

Some policies may be programmed in the ECT. For instance, it is the policy of some merchants to accept coupons of competing merchants. These policies may be downloaded to the DCC or remain only on the ECT. In one embodiment, the retailer's ECT provides the DCC with information about what to search. For instance the ECT at one retail establishment may tell the DCC to search for coupons of a competing establishment, if it accepts them. In one embodiment, a coupon is authenticated using information on a server 204.

The present system and method provides additional integrity to the manufacturers. Today, when a cashier scans a coupon, sometimes it does not register the discount. Often, the cashier will manually enter the discount without checking to see if the item advertised on the coupon has actually been purchased. This is problematic when similar, but not exact items from the manufacturer are purchased. The present system and method may preclude (or allow, based on policy) similar items to receive the advertised discount.

It may be necessary for the ECT to connect to the manufacturer's server or Web site (206) to validate the coupon. For instance, if only the first 2000 consumers to purchase an item are authorized to receive a discount, then the manufacturer's server must be contacted to verify the number of consumers who have already taken advantage of the coupon.

There may be incentives to remain with the same merchant based on dollar or point kick-back based on sharing or on timeliness of use. Sharing a coupon in proximity of an ECT or facilitated by an ECT may award the consumer with additional incentives. In one embodiment, in addition to (or in lieu of) peer-to-peer sharing the ECT facilitates sharing of coupons. The ECT requests an automatic download of all shareable coupons when a consumer is proximate to the ECT. In one embodiment, when a consumer checks out at the cashier station, all applicable shared coupons are applied. In another embodiment, sharable coupons are automatically pushed to the consumer's DCC (based on the selected profile and filters). Thus, animated coupons may display advertisements on the DCC while the consumer is still shopping, thereby encouraging additional sales.

In another embodiment, the coupon information may have a field that tracks the number of times it has been shared or used. Further incentives may be awarded based on how many times the coupon has been shared. A number of uses may be downloaded from the manufacturer's server to enable the consumer to receive a warning that the number of use limit has nearly been reached. This allows a consumer who is almost ready to commit to a purchase to be swayed by the limited use coupon to act immediately.

Since each coupon in the system may have a small embedded program, a short snippet of code may be embedded that can track the number of people to whom the coupon has been beamed. Alternatively, when a user redeems the coupon, the user may be made aware of how many people have redeemed the coupon. Thus, the store may adjust the user's reward for helping with the distribution of the coupon. It is possible, if the user has distributed a coupon to 20 friends on the network, the programmable coupon determines that the user is to receive that box of cereal for free, for instance.

In one embodiment, the DCC is not mobile, such as a home or business-based personal computer. Downloads of coupons may be performed via a network, such as the Internet. A user may shop at a merchant location on-line, i.e., a virtual location on the network. The ECT may be located at the merchant site or be remotely coupled to the merchant site. A user may share coupons with peers via e-mail, instant messaging or other communication. This embodiment works similarly to the mobile model, where digital coupons are stored in the non-mobile DCC and are automatically redeemed upon check-out. Entering a merchant's virtual location is similar to entering a physical location and coupons may be automatically downloaded upon entering. Navigating the merchant's web pages is similar to physically moving about the store and opening a specific web page may automatically download a proximity-based coupon.

The techniques described herein are not limited to any particular hardware or software configuration; they may find applicability in any computing, consumer electronics, or processing environment. The techniques may be implemented in hardware, software, or a combination of the two. The techniques may be implemented in programs executing on programmable machines such as mobile or stationary computers, personal digital assistants, cellular telephones and pagers, consumer electronics devices, and other electronic devices, that may include a processor, a storage medium readable by the processor (including volatile and non-volatile memory and/or storage elements), at least one input device, and one or more output devices. Program code is applied to the data entered using the input device to perform the functions described and to generate output information. The output information may be applied to one or more output devices. One of ordinary skill in the art may appreciate that the invention can be practiced with various system configurations, including multiprocessor systems, minicomputers, mainframe computers, independent consumer electronics devices, and the like. The invention can also be practiced in distributed computing environments where tasks may be performed by remote processing devices that are linked through a communications network.

Each program may be implemented in a high level procedural or object oriented programming language to communicate with a processing system. However, programs may be implemented in assembly or machine language, if desired. In any case, the language may be compiled or interpreted.

Program instructions may be used to cause a general-purpose or special-purpose processing system that is programmed with the instructions to perform the operations described herein. Alternatively, the operations may be performed by specific hardware components that contain hardwired logic for performing the operations, or by any combination of programmed computer components and custom hardware components. The methods described herein may be provided as a computer program product that may include a machine accessible medium having stored thereon instructions that may be used to program a processing system or other electronic device to perform the methods. The term “machine accessible medium” used herein shall include any medium that is capable of storing or encoding a sequence of instructions for execution by the machine and that cause the machine to perform any one of the methods described herein. The term “machine accessible medium” shall accordingly include, but not be limited to, solid-state memories, optical and magnetic disks, and a carrier wave that encodes a data signal. Furthermore, it is common in the art to speak of software, in one form or another (e.g., program, procedure, process, application, module, logic, and so on) as taking an action or causing a result. Such expressions are merely a shorthand way of stating the execution of the software by a processing system cause the processor to perform an action or produce a result.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

1. A system for reward-based electronic coupon redemption, comprising:
a first digital coupon carrier storing a plurality of digital coupons;
an electronic coupon terminal capable of communication with the first digital coupon carrier, wherein a digital coupon residing on the first digital coupon carrier, the digital coupon being for a discount on one of a good and a service, is capable of being identified by the electronic coupon terminal for redemption for the one of a good and a service.

2. The system as recited in claim 1, wherein the first digital coupon carrier is configured to share coupons among a plurality of digital coupon carriers.

3. The system as recited in claim 2, wherein user profile information defining user preferences for coupon sharing and desired goods and services is stored in the first digital coupon carrier.

4. The system as recited in claim 2, wherein sharing of coupons by the first digital coupon carrier results in receiving a reward.

5. The system as recited in claim 4, wherein the reward is selected from the group consisting of a merchant coupon, a manufacturer coupon, a service provider coupon, a cash equivalent item, and a quantity of points used for redemption of a future reward.

6. The system as recited in claim 2, wherein the first digital coupon carrier is configured to automatically share coupons based on a selected sharing profile.

7. The system as recited in claim 6, wherein coupons are automatically shared with one of the electronic coupon terminal and at least one of the plurality of digital coupon carriers.

8. The system as recited in claim 2, wherein the first digital coupon carrier is configured to send a selected digital coupon on demand to one of a plurality of digital coupon carriers.

9. The system as recited in claim 8, wherein sending a digital coupon to one of a plurality of digital coupon carriers sends a copy of the digital coupon.

10. The system as recited in claim 8, wherein sending a digital coupon to one of a plurality of digital coupon carriers sends a unique digital coupon from the first digital coupon carrier to the one of a plurality of digital coupon carriers, wherein the first digital coupon carrier can no longer redeem the sent digital coupon.

11. The system as recited in claim 1, wherein the electronic coupon terminal is configured to communicate with a manufacturer's server, wherein the communication facilitates authentication of the manufacturer's coupons prior to redemption.

12. A digital coupon carrier, comprising:
a plurality of digital coupons, each digital coupon being for a discount on one of a good and a service, and capable of being identified by an electronic coupon terminal for redemption for the one of a good and a service, and wherein the digital coupon carrier is configured to share coupons among a plurality of peer digital coupon carriers; and
a user profile comprising information defining user preferences for coupon sharing and desired goods and services.

13. The digital coupon carrier as recited in claim 12, wherein sharing of coupons results in receiving a reward.

14. The digital coupon carrier as recited in claim 13, wherein the reward is selected from the group consisting of a merchant coupon, a manufacturer coupon, a service provider coupon, a cash equivalent item, and a quantity of points used for redemption of a future reward.

15. The digital coupon carrier as recited in claim 12, wherein the electronic coupon terminal is configured to communicate with a manufacturer's server, wherein the communication facilitates authentication of the manufacturer's coupons prior to redemption.

16. The digital coupon carrier as recited in claim 12, wherein the digital coupon carrier is configured to automatically share coupons based on a selected sharing profile.

17. The digital coupon carrier as recited in claim 16, wherein coupons are automatically shared with one of the electronic coupon terminal and a peer digital coupon carrier.

18. The digital coupon carrier as recited in claim 12, wherein the digital coupon carrier is configured to send a selected digital coupon on demand to a peer digital coupon carrier.

19. The digital coupon carrier as recited in claim 18, wherein sending a digital coupon to the peer digital coupon carrier sends a copy of the digital coupon.

20. The digital coupon carrier as recited in claim 18, wherein sending a digital coupon to the peer digital coupon carrier sends a unique digital coupon from the digital coupon carrier to the peer digital coupon carrier, wherein the digital coupon carrier can no longer redeem the sent digital coupon.

21. The digital coupon carrier as recited in claim 12, further comprising a display element, the display element being capable of displaying advertisements for goods, services and merchants, wherein a displayed advertisement corresponds to at least one digital coupon stored in the digital coupon carrier.

22. The digital coupon carrier as recited in claim 21, wherein an advertisement must be displayed on the display element prior to redemption of the corresponding digital coupon.

23. The digital coupon carrier as recited in claim 22, wherein displaying an advertisement results in reception of a reward.

24. The digital coupon carrier as recited in claim 12, further comprising a display element and user input device, the display element and user input device allowing a user to play a video game on the digital coupon carrier, wherein playing the game enables the user to receive a digital coupon.

25. The digital coupon carrier as recited in claim 12, wherein the digital coupon carrier is configured to communicate with the electronic coupon terminal via one of a wired and wireless means.

26. The digital coupon carrier as recited in claim 12, wherein the digital coupon carrier automatically requests sharable coupons corresponding to items identified by the user profile.

27. The digital coupon carrier as recited in claim 26, wherein the automatic request is communicated to at least one of a peer digital coupon carrier and an electronic coupon terminal.

28. The digital coupon carrier as recited in claim 12, wherein the digital coupon carrier is configured to accept digital coupons having embedded programs.

29. The digital coupon carrier as recited in claim 12, further comprising coupon redemption policy information.

30. The digital coupon carrier as recited in claim 12, wherein when the digital coupon carrier is moved proximate to an item, the digital coupon carrier receives a digital coupon corresponding to the proximate item.

31. The digital coupon carrier as recited in claim 12, wherein the digital coupon carrier is configured to communicate with an information source, the information source providing information corresponding to a selected digital coupon.

32. An electronic coupon terminal, comprising:
a digital coupon authenticator configured to communicate with a digital coupon carrier, wherein a plurality of digital coupons reside on the digital coupon carrier, a digital coupon being for a discount on one of a good and a service and capable of being identified by the electronic coupon terminal for redemption for the one of a good and a service, and wherein the digital coupon carrier is configured to share coupons among a plurality of digital coupon carriers; and
an information store comprising coupon authentication information, wherein the digital coupon authenticator accesses the information store to authenticate digital coupons prior to redemption.

33. The electronic coupon terminal as recited in claim 32, wherein the electronic coupon terminal communicates with one of a manufacturer's server, a merchant's server, and a digital coupon carrier to determine coupon policies necessary to determine redemption authentication.

34. The electronic coupon terminal as recited in claim 33, wherein the digital coupon to be redeemed comprises coupon policy information to be used by the digital coupon authenticator.

35. A method for using mobile digital coupons, comprising:
generating an electronic list of items to be purchased;
querying a digital coupon carrier for coupons possible for redemption based on the electronic list of items to be purchased;
searching a plurality of digital coupons stored on the digital coupon carrier for relevant digital coupons,
transmitting a list of relevant digital coupons to a digital coupon authenticator;
authenticating the list of relevant digital coupons; and
applying appropriate discounts to the list of items based on the authenticated list of digital coupons.

36. The method as recited in claim 35, further comprising accessing information on a manufacturer's server to facilitate authentication of the list of relevant digital coupons.

37. The method as recited in claim 35, further comprising providing at least one reward to the digital coupon carrier based on redeemed coupons.

38. The method as recited in claim 35, further comprising automatically adjusting a discount value of a digital coupon based on timeliness of redemption.

39. The method as recited in claim 38, wherein a time frame for valid redemption is less than one hour.

40. The method as recited in claim 38, wherein a time frame for valid redemption is in a range of one hour to one day.

41. The method as recited in claim 38, wherein a time frame for valid redemption is in a range of one day to one year.

42. The method as recited in claim 38, wherein a time frame for valid redemption is more than one year.

43. The method as recited in claim 35, further comprising automatically requesting rebate redemption based on an item purchased and a user profile residing on the digital coupon carrier.

44. The method as recited in claim 35, wherein the digital coupon carrier is a device selected from the group consisting of a mobile and a non-mobile device.

45. A machine accessible medium containing instructions that, when executed, cause a machine to:
selectively accept digital coupons based on a user profile, wherein digital coupons requiring acceptance are automatically sent by at least one of an electronic coupon terminal and a peer digital coupon carrier;
search a plurality of digital coupons stored on the digital coupon carrier for relevant digital coupons, wherein relevant digital coupons are determined by an electronic list of items to be purchased; and
transmit a list of relevant digital coupons to a digital coupon authenticator for authentication, wherein appropriate discounts are applied to the list of items based on the coupon policies determined from at least one of a digital coupon information; a merchant database, a manufacturer database, and a electronic coupon terminal database.

46. The machine accessible medium as recited in claim 45, further comprising instructions that when executed cause the machine to accept a reward, wherein the reward is offered based on redemption of a digital coupon.
